(19) United States
(12) Patent Application Publication
(10) Pub. No.: US 2023/0255139 A1
(43) Pub. Date: Aug. 17, 2023

(54) MOWER

(71) Applicant: TOYOTA JIDOSHA KABUSHIKI KAISHA, Toyota-shi (JP)

(72) Inventors: Shinsuke SATO, Toyota-shi (JP); Takehito SAKAKIBARA, Nisshin-shi (JP)

(73) Assignee: TOYOTA JIDOSHA KABUSHIKI KAISHA, Toyota-shi (JP)

(21) Appl. No.: 18/062,133

(22) Filed: Dec. 6, 2022

(30) Foreign Application Priority Data
Feb. 15, 2022 (JP) 2022-021600

(51) Int. Cl. A01D 34/00; A01B 69/00; A01B 69/04

(52) U.S. Cl. CPC A01D 34/008; A01B 69/001; A01B 69/008; A01D 2101/00

(57) ABSTRACT

The mower includes a mower body having a mower blade portion for mowing grass, a first position estimation unit for estimating a self position of the mower main body using a satellite positioning system, a second position estimation unit for estimating a self position of the mower body using a sensor portion provided in the mower body, a detection unit for detecting a portion covered with grass and tree on a preset travel path, and an automatic travel control unit for causing the mower body to travel on the travel path with reference to the self position estimated by the first position estimation unit, and for causing the mower body to travel by switching to refer to the self position estimated by the second position estimation unit at a portion covered with the grass and tree detected by the detection unit.

### CROSS-REFERENCE TO RELATED APPLICATION

This application claims priority to Japanese Patent Application No. 2022-021600 filed on Feb. 15, 2022, incorporated herein by reference in its entirety.

### BACKGROUND

### 1. Technical Field

The present disclosure relates to a mower.

### 2. Description of Related Art

Regarding a lawn mower that travels automatically disclosed in Japanese Unexamined Patent Application Publication No. 9-128045 (JP 9-128045 A), the lawn mower is manually operated in advance in a work-target area and at the same time, a survey is performed by using a Global Positioning System (Global Positioning Satellite) (GPS) to generate a route of the lawn mower based on the survey data.

### SUMMARY

In the lawn mower described in JP 9-128045 A, when performing lawn mowing by automatic traveling, for example, when the traveling route is covered with a tree or the like, there is a possibility that the accuracy of the self-position estimation is lowered by measurement using GPS.

The present disclosure provides a mower capable of suppressing a decrease in accuracy of self-position estimation during automatic traveling.

A mower according to the present disclosure includes: a mower body including a cutting blade portion for cutting grass; a first position estimation unit that estimates a self position of the mower body using a satellite positioning system; a second position estimation unit that estimates the self position of the mower body using a sensor unit provided on the mower body; a detection unit that detects a portion covered with plants on a preset traveling road; and an automatic travel control unit that causes the mower body to travel on the traveling road with reference to the self position estimated by the first position estimation unit, and that causes the mower body to travel by switching so as to refer to the self position estimated by the second position estimation unit in the portion covered with the plants detected by the detection unit.

In the mower according to the present disclosure, the mower body is provided with a cutting blade portion for cutting grass. Therefore, grass can be cut by the cutting blade portion. Further, the mower according to the present disclosure includes a first position estimation unit that estimates a self position of the mower body using a satellite positioning system, and a second position estimation unit that estimates a self position of the mower body using a sensor unit provided in the mower body. Therefore, the first position estimation unit and the second position estimation unit can estimate the self position. Further, the mower according to the present disclosure includes a detection unit that detects a portion covered with plants on a preset traveling road. Therefore, it is possible to detect the portion covered with the plants by the detection unit.

Further, in the mower according to the present disclosure, in particular, an automatic travel control unit causes the mower body to travel on the traveling road with reference to the self position estimated by the first position estimation unit, and causes the mower body to travel by switching so as to refer to the self position estimated by the second position estimation unit in the portion covered with the plants detected by the detection unit. Accordingly, it is possible to estimate the self position using the sensor unit instead of the satellite positioning system at a place where it is considered difficult to estimate the self position by the satellite positioning system, and thus it is possible to suppress a decrease in the accuracy of the self-position estimation.

In the mower according to the present disclosure, the detection unit: acquires RGB image data including color information and ortho image data corresponding to an imaging area of the RGB image data and including point cloud data; identifies the plants based on the color information in the RGB image data; and identifies height of the plants based on height information of the point cloud data in the ortho image data to detect the portion covered with the plants.

With the mower according to the present disclosure, the position of the plants can be identified by the RGB image data, and the height of the plants can be identified by the ortho image data. Therefore, the height of the plants on the traveling road can be identified based on the ortho image data and the RGB image data.

In the mower according to the present disclosure, the detection unit compares first image data that is an image including the traveling road and acquired at a first time with second image data acquired at a second time different from the first time to detect the portion covered with the plants.

With the mower according to the present disclosure, the detection unit detects the portion covered with the plants by comparing the first image data and the second image data acquired at different times. Therefore, it is possible to identify the portion covered with the plants on the traveling road based on the first image data and the second image data.

In the mower according to the present disclosure, the first time is a mowing time, and the second time is a time in which there are less plants than the mowing time.

With the mower according to the present disclosure, it is possible to acquire an image covered with the plants and an image less covered with the plants than the image in a predetermined portion on the traveling road. Therefore, by comparing the images, it is possible to easily identify a portion covered with the plants.

In the mower according to the present disclosure, the sensor unit includes at least one of a plurality of sensors including a distance measuring sensor, a camera, a gyro sensor, a magnetic sensor, an acceleration sensor, and a radar sensor.

With the mower according to the present disclosure, it is possible to acquire information on the position of the mower body using at least one of a plurality of sensors including a distance measuring sensor, a camera, a gyro sensor, a magnetic sensor, an acceleration sensor, and a radar sensor. This makes it possible to estimate the self position of the mower body from the information on the position of the mower body.

As described above, the mower according to the present disclosure has an excellent effect that it is possible to suppress a decrease in the accuracy of self-position estimation during automatic traveling.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating a configuration of a mower according to an embodiment of the present disclosure;

FIG. 2 is a bottom perspective view of the mower of FIG. 1;

FIG. 3 is a perspective view schematically illustrating a configuration of a cutting blade portion of the mower of FIG. 1;

FIG. 4 is a block diagram illustrating a hardware configuration of a mower according to an embodiment of the present disclosure;

FIG. 5 is a block diagram illustrating a functional configuration of a mower according to an embodiment of the present disclosure;

FIG. 6 is a plan view schematically showing an entire hydroponic land region including a traveling path at a grass cutting time;

FIG. 7 is a side view schematically showing a traveling road in a grass cutting period;

FIG. 8 is a flowchart illustrating a series of processes of a mower according to an embodiment of the present disclosure; and

FIG. 9 is a side view schematically showing a traveling road in winter.

### DETAILED DESCRIPTION OF EMBODIMENTS

A grass mower 10 according to an embodiment of the present disclosure will be described with reference to the drawings. Note that an arrow UP illustrated in each drawing indicates an upper side in the vehicle up-down direction. The arrow FR indicates the front side in the vehicle front-rear direction. The arrow LH indicates the left side in the vehicle width direction. The arrow RH indicates the right side in the vehicle width direction. In the following description, the up-down direction and the front-rear direction respectively mean the up-down direction in the vehicle up-down direction and the front-rear direction in the vehicle front-rear direction. The left-right direction means the left-right direction in the vehicle width direction.

### Configuration of the Mower 10

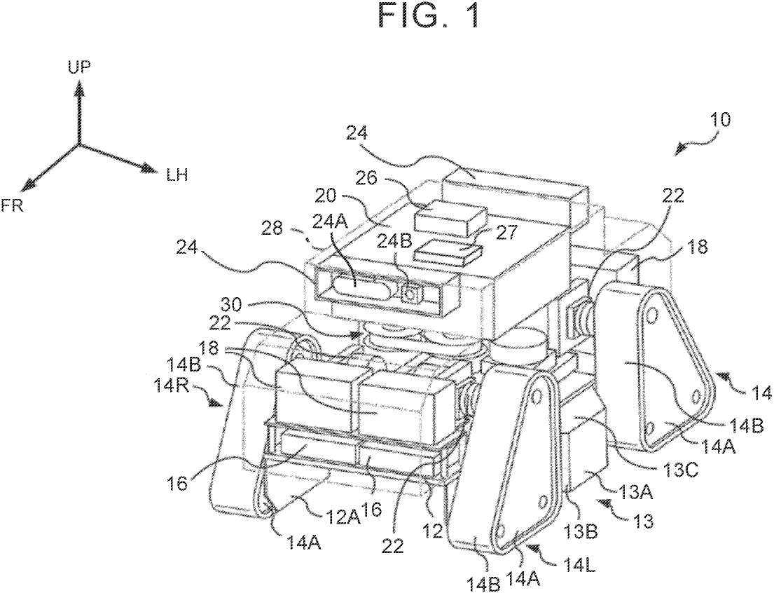

The mower 10 according to the first embodiment is a self-propelled mower. As an example, the grass mower 10 performs grass mowing of a ridge of a rice paddy field, a field, or the like. As shown in FIG. 1 as an example, the mower 10 as the mower body includes a main body portion 12, a crawler portion 14 as a driving portion, a motor controller 16, a battery device 18, a control device 20, a driving motor 22, a camera unit 24, a GPS device 26, a sensor portion 27, an exterior cover portion 28, and a cutting blade portion 30.

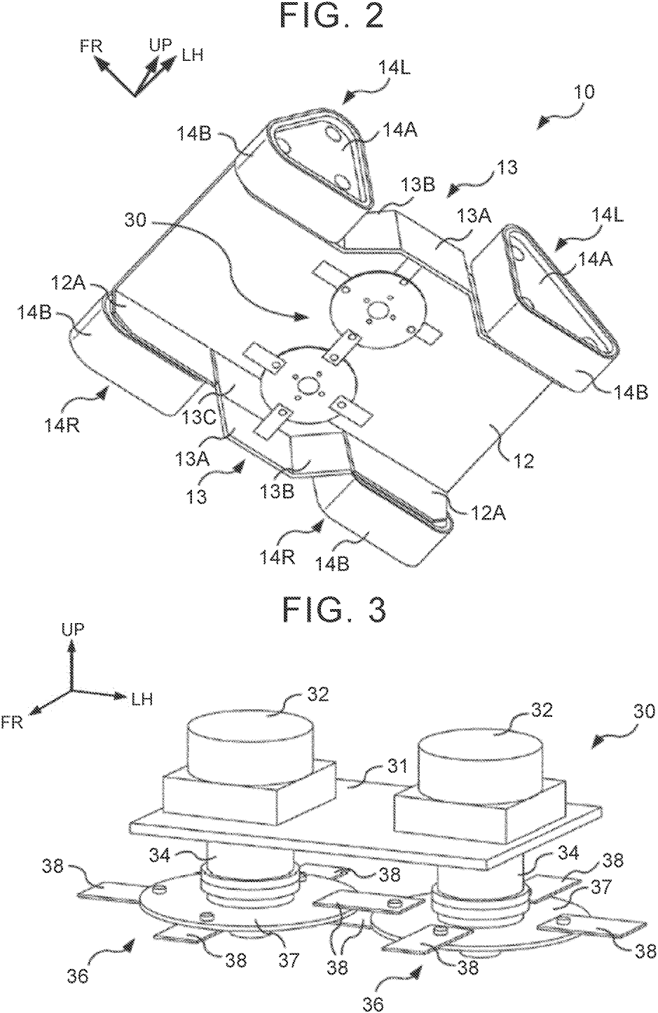

As shown in FIGS. 1 and 2, the main body portion 12 is formed of a substantially rectangular plate material. Various devices are placed on the upper surface of the main body portion 12. Further, the main body portion 12 is provided with an undercover 12A. The undercover 12A covers the vehicle-width-direction inner sides of the four crawler portions 14 described later. The undercover 12A is formed of a plate material. The undercover 12A extends in a substantially rectangular shape downward from both vehicle-width-direction end portions of the main body portion 12 at positions corresponding to the four crawler portions 14. In the present embodiment, as an example, although the main body portion 12 and the under-cover 12A are integrally formed, it may be formed separately.

Further, the main body portion 12, between the two undercover 12A provided on the left and right, respectively, the cutting blade cover 13 is provided. The cutting blade cover 13 covers the cutting blade 36 of the cutting blade portion 30 described later. The cutting blade cover 13 is formed of a plate material, and both ends thereof are connected to the undercover 12A of the two crawler portions 14. The main body portion 12, the undercover 12A, and the cutting blade cover 13 are made of, for example, a metal material such as steel or aluminum, a fiber-reinforced plastic material, or the like.

The cutting blade cover 13 includes a central portion 13A, two oblique portions 13B, and an upper 13C. The central portion 13A is formed in a rectangular shape. The central portion 13A protrudes outward from the undercover 12A in the vehicle-width direction. The two oblique portions 13B are provided at both ends of the central portion 13A in the front-rear direction of the vehicle. The oblique portion 13B extends obliquely from both ends of the central portion 13A in the front-rear direction toward the undercover 12A. The upper 13C is formed in a substantially trapezoidal shape. The four sides of the upper 13C are connected to the main body portion 12, the central portion 13A, and the two oblique portions 13B, respectively. In the present embodiment, the cutting blade cover 13 includes, for example, the cutting blade cover 13, the main body portion 12, and the undercover 12A separately formed. However, it may also be formed integrally. The cutting blade cover 13 prevents foreign matter from being inserted into the cutting blade 36 from the side surface side of the mower 10, that is, from the left and right sides, and prevents the cut grass from being scattered to the side surface side of the mower 10.

The crawler portions 14 are provided on both left and right sides in the front-rear direction. The mower 10 of the present embodiment includes four crawler portions 14. The crawler portions 14 include a rotating portion 14A and a crawler 14B. The rotating portion 14A is formed of a substantially right-angled triangular prism. The rotating portion 14A is rotated about an axial direction along the vehicle-width direction. The crawler 14B is a rubber-made member that covers the outer peripheral surface of the rotating portion 14A around the shaft. The crawler 14B is formed in a belt-like shape. The outer surface of the crawler 14B is formed with irregularities (not shown). The crawler 14B is configured so that the traveling property can be maintained even when the traveling surface is unstable due to the unevenness. A shaft (not shown) of the rotating portion 14A is connected to a motor shaft (not shown) of the driving motor 22. The shaft of the rotating portion 14A is rotated by the driving motor 22. In the present embodiment, the two front and rear crawler portions 14 on the left side in the vehicle width direction may be referred to as a left crawler portion 14L, and the two front and rear crawler portions 14 on the right side in the vehicle width direction may be referred to as a right crawler portion 14R.

The motor controller 16 drives and controls the driving motor 22 and a cutting blade motor 32 described later. The mower 10 of the present embodiment includes four driving motors 22 and two cutting blade motors 32 as will be described later. Therefore, the mower 10 of the present embodiment includes, as an example, four motor controllers 16A to 16D for driving and controlling the four driving motors 22 respectively, and two motor controllers 16E, 16F for driving and controlling the two cutting blade motors 32 respectively, a total of six motor controllers 16A to 16F.

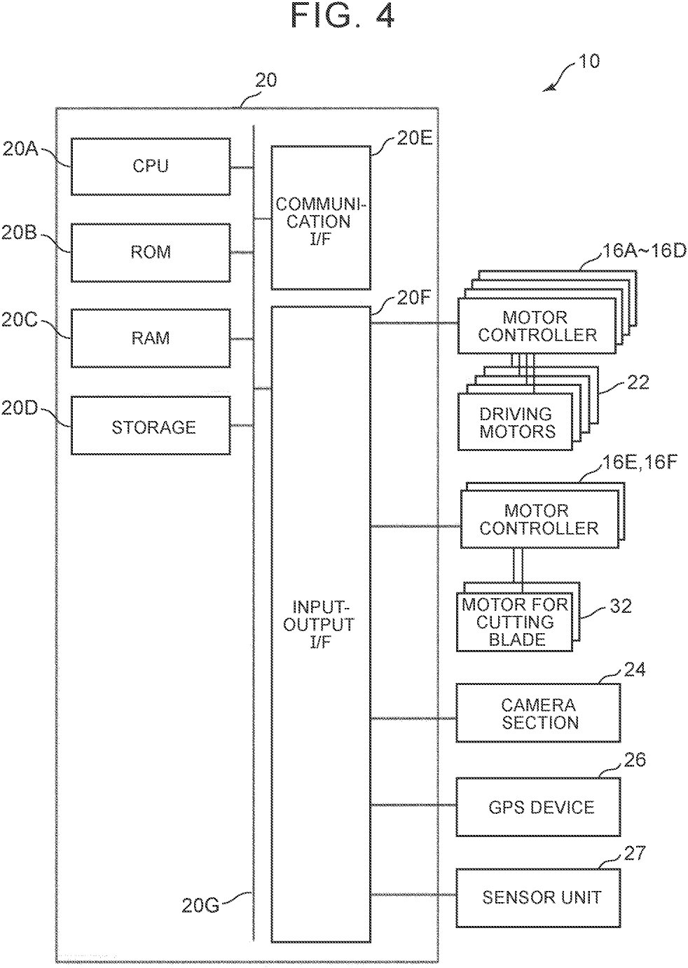

The motor controllers 16A to 16D for driving and controlling the driving motor 22 are electrically connected to the driving motor 22 and the control device 20 (see FIG. 4). The motor controllers 16A to 16D control the driving of the rotating portion 14A, that is, the crawler portion 14 connected to the driving motor 22. The motor controllers 16E, 16F for driving and controlling the cutting blade motor 32 are electrically connected to the cutting blade motor 32 and the control device 20 (see FIG. 4). The motor controllers 16E, 16F drive and control a cutting blade 36, which will be described later, connected to the cutting blade motor 32.

The battery device 18 serves as a driving source of the driving motor 22. The battery device 18 is, for example, a rechargeable DC power supply having a rated voltage of 18 V and a rated capacity of 6.0 Ah. The battery device 18 includes, for example, a secondary battery such as a lithium-ion secondary battery or a nickel-hydrogen battery. The battery device 18 may be a capacitor such as an electric double layer capacitor. In the mower 10 of the present embodiment, four battery devices 18 are provided as an example. The four battery devices 18 supply electric power to electronic devices mounted on the mower 10, such as the driving motor 22 and the cutting blade motor 32.

The control device 20 is a device that controls the overall driving of the mower 10. The control device 20 is disposed on the upper side of the inside of the exterior cover portion 28. The control device 20 will be described in detail later.

Four driving motors 22 are provided in the mower 10 of the present embodiment. The driving motor 22 is constituted by, for example, a DC brushless motor. The four driving motors 22 are connected to each of the four crawler portions 14, and are driven by commands from the motor controllers 16A to 16D.

The camera unit 24 is a camera capable of capturing an image of the periphery of the mower 10. The camera unit 24 is provided on the front side and the rear side of the upper outer surface of the exterior cover portion 28 in the mower 10 of the present embodiment. Each of the camera units 24 provided on the front side and the rear side includes a 3D (three-dimensional) camera 24A and a Rasberry Pi camera 24B.

The GPS device 26 includes an antenna (not shown). The antenna receives a radio signal from a GPS satellite (not shown). The GPS device 26 is capable of measuring the current position of the mower 10. The GPS device 26 is provided on the upper side of the control device 20, and is fixed to the exterior cover portion 28. The satellite positioning system includes the GPS satellite and the GPS device 26.

The sensor unit 27 includes a three-axis acceleration sensor. The sensor unit 27 outputs gravitational acceleration in the left-right direction (horizontal direction: x direction), the front-rear direction (horizontal direction: y direction), and the up-down direction (vertical direction: z direction) of the mower 10. Further, the sensor unit 27 includes a gyro sensor, and detects the rotation of the mower 10, that is, the angular velocity.

The exterior cover portion 28 is formed in a box shape having an open lower side. The exterior cover portion 28 is a housing that covers the main body portion 12 from above.

The cutting blade portion 30 has a structure for cutting grass. Specifically, as shown in FIG. 3, the cutting blade portion 30 includes a rectangular plate-shaped base portion 31 disposed on the upper surface of the main body portion 12. The base portion 31 has a height adjustment structure (not shown) capable of height adjustment in the vertical direction with respect to the main body portion 12. The height adjustment structure may be manual or automatic, for example. As the height adjustment structure, a known structure can be used.

A cutting blade motor 32 is mounted on the upper surface of the base portion 31 at a predetermined interval in the left-right direction. In the present embodiment, the cutting blade motor 32 is constituted by a DC bracelet motor as an example.

Each of the two cutting blade motors 32 includes a motor shaft 34 through which an insertion hole (not shown) of the base portion 31 is inserted. A cutting blade 36 is rotatably fixed to the lower ends of the two motor shafts 34.

The cutting blade 36 is formed in a disk shape, and includes a disk portion 37 rotatably fixed to the motor shaft 34, and four blade edges 38 of a rectangular shape fixed so as to project outward from the outer periphery of the disk portion 37 in four directions. The left and right cutting blades 36 are arranged to be slightly shifted in the vertical direction (height direction) so that the cutting edges 38 do not interfere with each other. The cutting blade 36 is rotationally driven by the cutting blade motor 32 to cut grass.

In the present embodiment, the height of the base portion 31 is adjusted in the vertical direction by the above-described height adjustment structure. By this adjustment, the height position of the cutting blade 36 can also be adjusted. In the present embodiment, as an example, the height is adjusted so that the cutting edge 38 is positioned at a height of 50 mm from the ground. As an example, the cutting edge 38 can be adjusted in height to a plurality of heights, such as a height of 80 mm or 100 mm, in addition to a height of 50 mm from the ground. As a result, grass cutting can be performed at a plurality of heights.

Further, in the present embodiment, the control device 20 controls the traveling of the mower 10 based on the data acquired by the camera unit 24, the GPS device 26, and the sensor unit 27, and a preset traveling path stored in a storage 20D to be described later.

### Hardware Configuration of the Mower 10

Next, the control device 20 will be described in detail. As illustrated in FIG. 4, the control device 20 mounted on the mower 10 includes a Central Processing Unit (CPU) (processor) 20A, Read-Only Memory (ROM) 20B, Random Access Memory (RAM) 20C, a storage 20D, a communication interface (communication I/F) 20E, and an input/output interface (input/output I/F) 20F, which are exemplary processors. The components are communicably connected to each other via a buss 20G.

CPU 20A is a central processing unit. CPU 20A executes various programs and controls each unit. That is, CPU 20A reads the program from ROM 20B or the storage 20D, and executes the program using RAM 20C as a working area. CPU 20A performs control of the above-described configurations and various arithmetic processes in accordance with programs recorded in a ROM 20B or a storage 20D.

ROM 20B stores various programs and various data. RAM 20C temporarily stores a program/data as a working area. The storage 20D is composed of Hard Disk Drive (HDDs) or Solid State Drive (SSDs). The storage 20D stores various programs including an operating system and various data including map data. In addition, the storage 20D stores a preset travel path. In the present embodiment, ROM 20B or the storage 20D stores programs for performing various functions, various types of data, and the like.

The communication I/F 20E is interfaces for the mower 10 to communicate with servers and other devices (not shown). As the communication I/F 20E, for example, standards such as Ethernet (registered trademark), LTE, and FDDI, Wi-Fi (registered trademark) are used.

The input/output I/F 20F serve as interfaces for the control device 20 to communicate with the respective devices mounted on the mower 10. The control device 20 is communicably connected to respective devices described later via an input/output I/F 20F. These devices may be directly connected to the buss 20G.

Specifically, motor controllers 16A to 16D, motor controllers 16E, 16F, a camera unit 24, a GPS device 26, a sensor unit 27, and the like are connected to the input/output I/F 20F.

The motor controllers 16A to 16D output a control signal to the driving motor 22 based on the command signal inputted from the control device 20. The motor controllers 16A to 16D, the rotational speed of the driving motor 22, the rotational speed, and are capable of controlling the rotational direction and the like. Then, in the present embodiment, the rotation speed, the rotation speed, and the rotation direction of the motor controllers 16A to 16D are independently controlled by the control device 20 and the motor controllers 16A to 16D, thereby enabling the traveling direction of the mower 10 to be changed.

The motor controller 16E, 16F outputs a control signal to the cutting blade motor 32 based on the command signal inputted from the control device 20. Motor controller 16E, 16F, the rotational speed of the cutting blade motor 32, the rotational speed, and is capable of controlling the rotational direction and the like. Then, in the present embodiment, the rotation speed, the rotation speed, and the rotation direction of the motor controller 16E, 16F are independently controlled by the control device 20 and the motor controller 16E, 16F, thereby enabling the mowing state of the mower 10 to be changed.

The camera unit 24 is a camera that captures an image of the periphery of the mower 10. The captured images of the objects around the mower 10 are temporarily stored in the storage 20D.

The GPS device 26 functions as part of a satellite positioning system. The measured position information indicating the position of the mower 10 is temporarily stored in the storage 20D, and the position information of the mower 10 is updated at predetermined intervals.

The sensor unit 27 is a device that detects gravitational acceleration of the mower 10. The gravitational accelerations in the left-right direction (x direction), the front-rear direction (y direction), and the up-down direction (z direction) outputted by the sensor unit 27 are temporarily stored in the storage 20D. The data of the gravitational acceleration stored in the storage 20D is data in which noises are removed by applying a predetermined filter to the data of the gravitational acceleration outputted from the sensor unit 27.

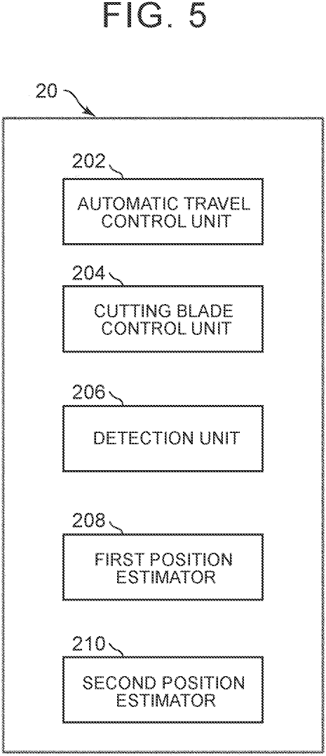

Next, the functional configuration of the control device 20 will be described with reference to FIG. 5. The control device 20 functions as an aggregate of the automatic travel control unit 202, the cutting blade control unit 204, the detection unit 206, the first position estimation unit 208, and the second position estimation unit 210 by CPU 20A reading and executing the executable program stored in ROM 20B.

The automatic travel control unit 202 receives a control signal to the motor controllers 16A to 16D by referring to the travel path, the map data, the captured image captured by the camera unit 24, and the self-position of the mower 10 estimated by the first position estimation unit 208 and the second position estimation unit 210, which will be described later, which are stored in the storage 20D. The automatic travel control unit 202 controls the driving motor 22 via the motor controllers 16A to 16D so that the mower 10 travels along the travel path. A method of causing the mower 10 to travel with reference to the self-position estimated by the first position estimation unit 208 and the second position estimation unit 210 will be described in detail later.

When an object approaching the mower 10 is detected in the captured image captured by the camera unit 24, the automatic travel control unit 202 can control the driving motor 22 via the motor controllers 16A to 16D to pause the mower 10.

Cutting blade control unit 204, when the running of the mower 10 is started by the automatic travel control unit 202, the rotational speed of the cutting blade motor 32 which is set in advance in the motor controller 16E, 16F, the rotational speed, and inputs the rotational direction and the like. Cutting blade control unit 204, the rotational speed of the cutting blade motor 32 via the motor controller 16E, 16F, the rotational speed, and drives and controls the rotational direction and the like. Further, when an object approaching the mower 10 is detected in the captured image captured by the camera unit 24, or when an overload is applied to the cutting blade motor 32, the cutting blade control unit 204 can control the cutting blade motor 32 via the motor controller 16E, 16F to temporarily stop the rotation of the cutting blade 36.

The detection unit 206 detects a portion covered with a plant and a tree on a traveling path set in advance and stored in the storage 20D. In the present embodiment, the term “herb” includes leaves grown on branches of trees, grasses themselves, and the like. In the grass mower 10 of the present embodiment, the detection unit 206 specifies a part covered with the grass and tree on the basis of the RGB image data having color information and the ortho image data, which are images including the travel path set in advance and stored in the storage 20D. The ortho image data corresponds to an imaging area of the RGB image data, and includes point cloud data. A method of specifying a portion covered by the grass and tree on the traveling road by the detection unit 206 will be described in detail later.

The first position estimation unit 208 estimates the self position of the mower 10 using the satellite positioning system. Specifically, an antenna (not shown) of the GPS device 26 receives radio waves from GPS satellites in space and outputs the radio waves to the input/output I/F 20F. The first position estimation unit 208 acquires the radio wave signal outputted from the GPS device 26 via the input/output I/F 20F. The first position estimation unit 208 estimates the self position based on the radio wave signal. Specifically, the distance is estimated based on the time difference between the transmission time and the reception time of the radio wave signal. Since a known technique can be used for the method of estimating the self-position using the GPS device 26, a detailed description thereof will be omitted.

The second position estimation unit 210 estimates the self position of the mower 10 using the sensor unit 27. Specifically, the detection data acquired by the sensor unit 27, that is, the gyro sensor and the three-axis acceleration sensor is outputted to the input/output I/F 20F. The second position estimation unit 210 acquires the detected data outputted from the gyro sensor and the three-axis acceleration sensor via the input/output I/F 20F. The second position estimation unit 210 estimates the self position based on the detection data.

Specifically, the second position estimation unit 210 estimates the direction of the mower 10, that is, the moving direction, based on the angular velocity data output from the gyro sensor. Further, the second position estimation unit 210 estimates the movement distance based on the gravitational acceleration data output from the three-axis acceleration sensor.

Here, a method of specifying a portion covered with a vegetation on a traveling road by the detection unit 206 will be described. In the present embodiment, the detection unit 206 acquires, as an example, RGB image data which is an aerial image and is a color image having color information, and orthographic image (orthographic transformed image) data. The aerial image is captured by skipping the drone on which the camera is mounted. The ortho image data is data obtained by analyzing the data of the aerial image and accurately displaying the position and size of the subject. In the present embodiment, the ortho image data includes point group data represented by orthogonal coordinates (x, y, z).

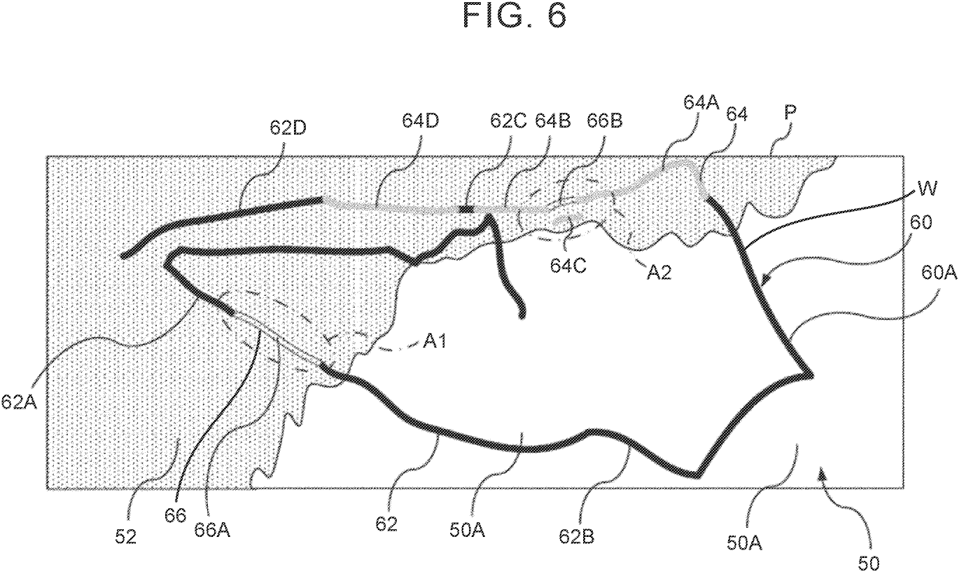

In the present embodiment, as an example, RGB image data (image data of an aerial photographed image) which is a plurality of aerial photographed images is acquired by flying a drone on which a camera is mounted over the area shown in FIG. 6 and photographing the area from each direction. The acquired data is stored in the storage 20D via the communication I/F 20E. Further, in the present embodiment, for example, the detection unit 206 converts a plurality of aerial images stored in the storage 20D into orthographic image data including point cloud data using a conversion tool such as Metashape (registered trademark). The coordinate position information in the RGB image data and the ortho image data converted from the RGB image data is associated with each other.

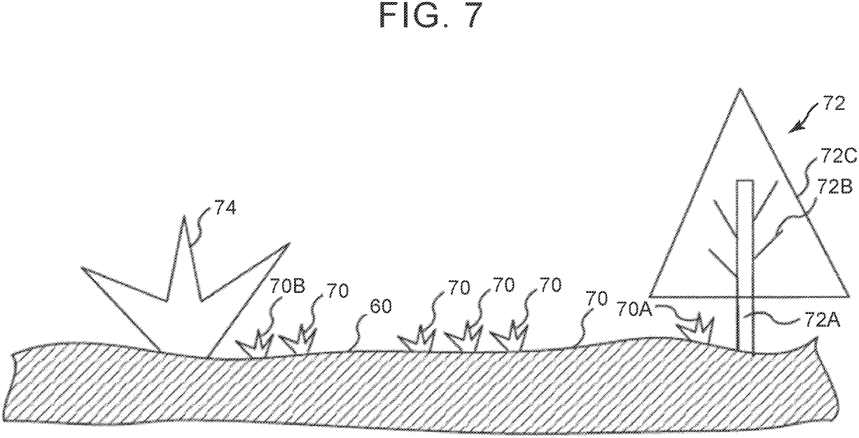

FIG. 6 is a plan view schematically showing the entire region of the hydroponic land 50 including the traveling road 60 at the grass cutting time. FIG. 7 is a side view schematically showing the traveling road 60 at the grass cutting time. In FIG. 6, a trajectory 60A indicating a self-position estimated by the first position estimation unit 208 is superimposed on the ortho-image P when the mower 10 travels on the traveling road 60. As shown in FIG. 6, in the hydroponic land 50, a ridge road W is provided at the boundary of the paddy field area 50A where water is stored so as to fill mud and prevent water from leaking to the outside. This ridge road W is a road on which vehicles can travel, and as shown in FIG. 7, grasses 70, grass 70A, trees 72, large grasses 74, and the like other than agricultural crops are grown.

The tree 72 includes a trunk 72A extending upward from the ground, a plurality of branch 72B extending obliquely upward from the outer periphery of the trunk 72A, and a leaf 72C extending from the branch 72B. Larger grasses 74 are grasses 70 and grasses that are taller than grass 70A. In the grass mower 10 of the present embodiment, as an example, a traveling road 60 on which the grass mower 10 travels is set on the ridge road W in order to mow the grass 70 grown on the ridge road W. Note that the traveling road 60 is set in advance based on RGB image data captured in the winter season, which is a period in which grass is less than the grass cutting period. The traveling road 60 may be set based on terrain information obtained by downloading from an external site, for example.

In the RGB image (not shown) corresponding to the ortho image P shown in FIG. 6, the boundary between the paddy field areas 50A is the ridge road W where the grass 70, the grass 70A, the leaf 72C of the tree 72, and the large grass 74 are present. Therefore, most of the ridge road W is green. Therefore, the detection unit 206 identifies the green region as a portion that is highly likely to be covered with grass. In addition, the area of the branch 72B without leaf 72C is brown. Therefore, the detection unit 206 identifies the brown region as a portion that is highly likely to be covered with a tree.

The detection unit 206 detects the height of the grass in the area of the grass and tree identified in the RGB image data as described above, based on the ortho image data. Specifically, the height of the grass is detected based on the height information of the point cloud data in the grass region identified in the RGB image data. When the detected height exceeds the predetermined height, the detection unit 206 detects an area exceeding the predetermined height as a part covered with the grass. Here, in the present embodiment, the “predetermined height” is, for example, 1 m. The detection unit 206 acquires a portion covered with a plant and a tree, specifically, as a coordinate position in the vertical direction and the horizontal direction in the ortho image P.

As shown in FIG. 6, the trajectory 60A of the self-position estimated by the mower 10 traveling on the traveling road 60 using the satellite positioning system by the first position estimation unit 208 has a first self-position 62 indicated by a black line and a second self-position 64 indicated by a gray line. The first self-position 62 is a self-position acquired with higher accuracy than the second self-position 64.

As an example, it is assumed that the mower 10 starts traveling from substantially the center of the ortho image P shown in FIG. 6. Here, as shown in FIG. 6, between the first path 62A and the second path 62B at the first self position 62, the first self position 62 and the second self position 64 are not present in the area indicated by the dashed-dotted frame A1, and the first path 66A at the third self position 66 indicated by the white line is present. The first path 66A is an area in which the first position estimation unit 208 cannot estimate its own position.

Specifically, the upper parts of the grass 70A and the grass 70B are covered with the leaf 72C of the tree 72 and the large grass 74, respectively. Therefore, when the mower 10 mows the grass 70A on the right side and the grass 70B on the left side in FIG. 7, radio waves from GPS satellites in space do not reach the antennas (not shown) of the GPS device 26 of the grass mower 10. As described above, the position where the radio wave signal cannot be received on the traveling road 60 is the third self-position 66.

In the present embodiment, the detection unit 206 detects a portion corresponding to the third self-position 66 as a portion covered with a plant and a tree. Therefore, in the present embodiment, at the location covered by the grass and tree detected by the detection unit 206, that is, at the third self-position 66, the automatic travel control unit 202 estimates the self-position of the grass mower 10 using the sensor unit 27 by the second position estimation unit 210 instead of the first position estimation unit 208.

Specifically, when the mower 10 reaches a portion covered by the grass and tree detected by the detection unit 206 from the first self-position 62, the automatic travel control unit 202 acquires the coordinate position of the self-position acquired by the first position estimation unit 208 at the first self-position 62 adjacent to the portion covered by the grass and tree. The automatic travel control unit 202 causes the mower 10 to travel by referring to the self-position calculated by adding the movement distance estimated by the second position estimation unit 210 with the coordinate position as a starting point.

Then, when the mower 10 reaches the first self-position 62 from the portion covered by the grass and tree detected by the detection unit 206, the automatic travel control unit 202 acquires the coordinate position of the self-position acquired by the first position estimation unit 208 at the first self-position 62 adjacent to the portion covered by the grass and tree. The automatic travel control unit 202 causes the mower 10 to travel by referring to the self position estimated by the first position estimation unit 208 in the subsequent first self position 62.

In the present embodiment, as shown in FIG. 6, the first self position 62 and the second self position 64 do not exist in the area indicated by the dashed-dotted frame A2 between the first path 64A and the second path 64B of the second self position 64 adjoining the second path 62B of the first self position 62, and the second path 66B of the third self position 66 indicated by the white line exists. In the area indicated by the frame A2, a third path 64C at the second self-position 64 is slightly deviated from the first path 64A and the second path 64B between the first path 64A and the second path 64B.

The antenna (not shown) of the GPS device 26 of the grass mower 10 receives a signal bounced back to a reflective object such as a leaf 72C of the tree 72 without receiving a radio signal from GPS satellites in space, thereby causing a reception delay. As a result, the third path 64C is generated.

Therefore, in the present embodiment, the automatic travel control unit 202 causes the mower 10 to travel with reference to the self-position estimated by the second position estimation unit 210 instead of the first position estimation unit 208 even in the second self-position 64 in which the self-position is acquired with accuracy lower than the first self-position 62.

Specifically, the detection unit 206 detects, in advance, a region in which the positioning accuracy decreases when an antenna (not shown) of the GPS device 26 receives a radio signal from a GPS satellite in space. Then, when the mower 10 travels in the region detected by the detection unit 206, that is, the region corresponding to the second self position 64, the automatic travel control unit 202 acquires the coordinate position of the self position acquired by the first position estimation unit 208 at the first self position 62 adjacent to the region. The automatic travel control unit 202 causes the mower 10 to travel by referring to the self-position calculated by adding the movement distance estimated by the second position estimation unit 210 with the coordinate position as a starting point.

In the traveling road 60 illustrated in FIG. 6 as an example, the automatic travel control unit 202 causes the mower 10 to travel on the traveling road 60 corresponding to the first path 62A, the second path 62B, the third path 62C, and the fourth path 62D at the first self-position 62 by referring to the self-position estimated by the first position estimation unit 208. Further, the automatic travel control unit 202 causes the mower 10 to travel by referring to the first path 64A, the second path 64B, the fourth path 64D, and the first path 66A and the second path 66B at the third self position 66 at the second self position 64 with reference to the self position estimated by the second position estimation unit 210.

### Automatic Travel Control Method

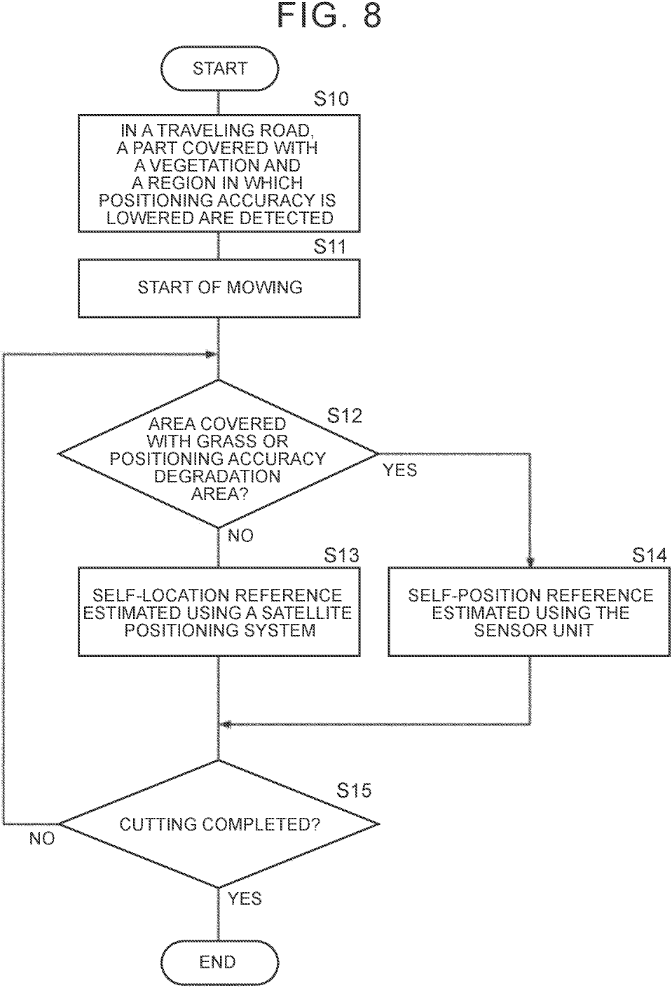

A series of processes of the automatic travel control method in the mower 10 will be described below with reference to a flowchart shown in FIG. 8. As illustrated in FIG. 8, in the grass mower 10 according to the first embodiment, first, in step S10, the detection unit 206 detects, as described above, a portion covered with the grass and the region where the positioning accuracy is deteriorated in the preset traveling road 60.

Next, in step S11, the automatic travel control unit 202 drives and controls the driving motor 22 to start the travel of the mower 10. Further, the cutting blade control unit 204 drives and controls the cutting blade motor 32 to start the grass cutting by the mower 10.

Next, in step S12, the automatic travel control unit 202 determines whether or not the vehicle is traveling over a portion covered with the grass and the tree detected by the detection unit 206 or a region where the positioning accuracy is reduced. In a case where the vehicle is not traveling in a portion covered with the grass or a region where the positioning accuracy is reduced (step S12; NO), the process proceeds to step S13. In step S13, the automatic travel control unit 202 causes the mower 10 to travel with reference to the self-position estimated by the first position estimation unit 208 using the satellite positioning system.

On the other hand, in step S12, where the grass is covered with the grass or the region where the positioning accuracy is reduced is traveling (step S12; YES), in step S14, the automatic travel control unit 202 causes the grass mower 10 to travel with reference to the self-position estimated by the second position estimation unit 210 using the sensor unit 27.

Next, in step S15, the automatic travel control unit 202 determines whether or not grass cutting has been completed. Specifically, the automatic travel control unit 202 determines whether or not the vehicle has finished traveling on a predetermined traveling road 60. If the grass clipping has not been completed (step S15; NO), CPU 20A proceeds to step S12 and causes the processing of step S12 and subsequent steps to be performed. On the other hand, when the mowing is completed (step S15; YES), the automatic travel control unit 202 stops the mower 10 and ends the mower.

### Operation and Effect of Embodiments

Next, operations and effects of the present embodiment will be described.

In the mower 10 according to the present embodiment, since the cutting blade portion 30 for cutting grass is provided, grass can be cut by the cutting blade portion 30. Further, the mower 10 includes a first position estimation unit 208 that estimates the self position of the mower 10 using the satellite positioning system, and a second position estimation unit 210 that estimates the self position of the mower 10 using the sensor unit 27 provided in the mower 10. Therefore, the first position estimation unit 208 and the second position estimation unit 210 can estimate the self position. In addition, the mower 10 includes a detection unit 206 that detects a portion covered with a vegetation on a traveling road 60 that is set in advance. Therefore, the detection unit 206 can detect a portion covered with the vegetation.

In addition, in the mower 10, in particular, the automatic travel control unit 202 causes the mower 10 to travel on the traveling road 60 with reference to the self-position estimated by the first position estimation unit 208, and causes the mower 10 to travel by switching so as to refer to the self-position estimated by the second position estimation unit 210 at a position covered by the grass and tree detected by the detection unit. Therefore, it is possible to estimate the self-position using the sensor unit 27 instead of the satellite positioning system at a place where it is considered difficult to estimate the self-position by the satellite positioning system. Therefore, it is possible to suppress a decrease in the accuracy of the self-position estimation.

Further, according to the grass mower 10 of the present embodiment, the position of the grass and tree can be specified by the RGB image data, and the height of the grass and tree can be specified by the ortho image data. Therefore, the height of the grass on the traveling road 60 can be specified on the basis of the ortho image data and the RGB image data.

### Modified Examples

In the above-described embodiment, the detection unit 206 detects a portion covered with the grass and tree on the basis of the RGB image data and the ortho image data at the grass cutting time. However, the present disclosure is not limited thereto. For example, by comparing the first image data acquired at the first time with the second image data acquired at a second time different from the first time, the portion covered with the grass and tree may be detected. In the present modification, as an example, the first time is the grass cutting time, and the second time is the winter time in which the grass is less than the grass cutting time.

In the present modification, an example in which both the first image data and the second image data are ortho image data will be described.

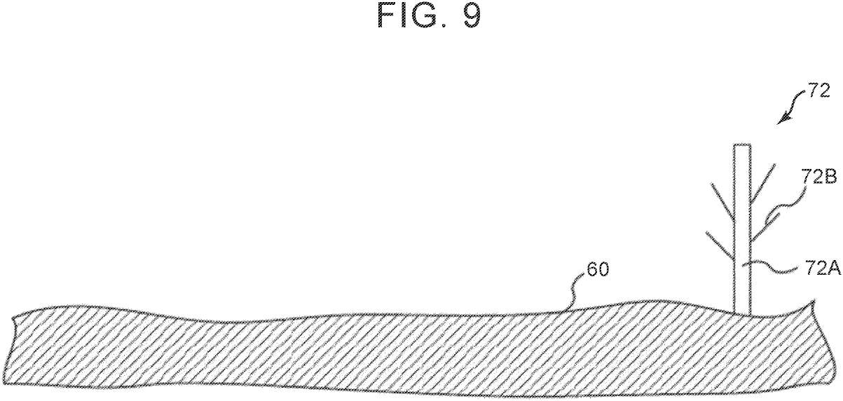

FIG. 9 is a side view schematically showing the traveling road 60 in winter. The location shown in FIG. 9 and the location shown in FIG. 7 are the same location. As shown in FIG. 9, grass 70, 70A, 70B, and large grass 74 are almost absent from the traveling road 60 at this time. In addition, there is no leaf 72C on the branch 72B of the tree 72. In this modification, RGB image data (image data of an aerial image) which is a plurality of aerial images in winter is acquired and stored in the storage 20D via the communication I/F 20E. Winter aerial images are acquired by flying a drone equipped with a camera over the area shown in FIG. 6 in winter to photograph the area from each direction. Further, in the present embodiment, for example, the detection unit 206 converts a plurality of winter aerial images stored in the storage 20D into winter orthographic image data including point cloud data using a conversion tool such as Metashape (registered trademark).

On the other hand, FIG. 7 is a side view schematically showing the traveling road 60 at the grass mowing time, which is the first time. As shown in this drawing, grass 70, 70A, 70B, and large grass 74 are grown on the traveling road 60 at this time. Leaves 72C are grown on the branch 72B of the tree 72. Then, in the same manner as in the winter season, the drone on which the camera is mounted is skipped over the area shown in FIG. 6, and the area is photographed from each direction to acquire RGB image data (image data of an aerial image) which is an aerial image of a plurality of grass cutting timings. The acquired data is stored in the storage 20D via the communication I/F 20E. Further, in the present embodiment, as an example, the detection unit 206 converts an aerial photographed image of a plurality of grass cutting timings stored in the storage 20D into orthographic image data of grass cutting timings including point cloud data using a conversion tool such as Metashape (registered trademark).

In the present modification, the detection unit 206 identifies (estimates) the height of the grass and the tree relative to the ground by comparing the ortho image data of the grass cutting time with the ortho image data of the winter. By comparing the ortho image data of the grass clipping time with the ortho image data of the winter, the detection unit 206 estimates a range in which a subject exceeding a predetermined height is present with respect to the ground as a “place where the grass and the tree grow”.

As described above, in the modified example, the detection unit 206 detects a portion covered with the grass and the tree by comparing the ortho image data acquired at different times. Therefore, the detection unit 206 can identify a portion covered with the grass and the tree on the traveling road 60 on the basis of the ortho image data acquired at different times.

Further, according to the modified example, it is possible to acquire the image covered with the grass and the image not covered with the grass and the tree at a predetermined position on the traveling road 60. Therefore, by comparing the images, it is possible to easily identify a portion covered with the grass and the tree.

In the mower 10 of the above-described embodiment, the second period is set as the winter period. However, the present disclosure is not limited thereto. For example, even in the winter season, the autumn season may be close to the winter season as long as the season in which the grass is less than the first season.

Further, in the mower 10 of the above-described embodiment, the automatic travel control unit 202 causes the mower 10 to travel on the traveling road 60 corresponding to the second self position 64 and the third self position 66 with reference to the self position estimated by the second position estimation unit 210. However, the present disclosure is not limited thereto. The automatic travel control unit 202 may cause the mower 10 to travel with reference to the self position estimated by the second position estimation unit 210 only on the traveling road 60 corresponding to the third self position 66.

Further, in the mower 10 of the above-described embodiment, the sensor unit 27 includes a three-axis acceleration sensor and a gyro sensor. However, the present disclosure is not limited thereto. The sensor unit 27 may be configured to include three acceleration sensors that respectively detect acceleration along one axis among three different axes. Any configuration may be used. The sensor unit 27 may be configured by one or more sensors including, for example, a distance measuring sensor, a camera, a gyro sensor, a magnetic sensor, an acceleration sensor, and a radar sensor as long as the self-position of the mower 10 can be estimated. Even with such a configuration, it is possible to estimate the own position of the mower 10 from the information regarding the position of the mower 10.

In the above-described embodiment, the GPS device 26 is used as the satellite positioning system, but the present disclosure is not limited to this. For example, known techniques such as Global Navigation Satellite System (GNSS) and Quasi-Zenith Satellite System (QZSS) can be used.

Further, in the crawler portion 14 of the above-described embodiment, the rotating portion 14A is formed of a substantially right-angled triangular column. However, the present disclosure is not limited thereto. The crawler portion 14 may have, for example, an elliptical shape or a circular shape. The crawler portion 14 can be changed as appropriate.

Further, in the above-described embodiment, the mower 10 is a four-wheel drive. However, the present disclosure is not limited to this, and may be a two-wheel drive.

In the above-described embodiment, the crawler portion 14 is adopted as the drive unit. However, the present disclosure is not limited thereto. The drive may be, for example, a wheel. Further, the drive unit of the mower of the present disclosure is not limited to four, and may have a structure having one drive unit on the left side and one drive unit on the right side.

In addition, various processors other than the CPUs may execute the respective processes executed by CPU 20A shown in FIG. 4 reading the software (program) in the above-described embodiment. Examples of such processors include Programmable Logic Device (PLDs), which are capable of changing circuit configurations after manufacturing such as Field-Programmable Gate Array (FPGA), and dedicated electric circuits, which are processors having circuit configurations designed exclusively for executing certain processes such as Application Specific Integrated Circuit (ASIC). Further, each process may be executed by one of these various processors, or a combination of two or more processors of the same type or different types (for example, a combination of multiple FPGAs, a combination of a CPU and an FPGA, and the like). Further, the hardware structure of these various processors is, more specifically, an electric circuit in which circuit elements such as semiconductor elements are combined.

In addition, the programs described in the above-described embodiments may be provided in a form recorded in a recording medium such as a Compact Disc Read Only Memory (CD-ROM), Digital Versatile Disc Read Only Memory (DVD-ROM), and Universal Serial Bus (USB). Further, the program may be downloaded from an external device via a network.

The embodiments of the present disclosure have been described as above. However, it is not without saying that the present disclosure is not limited to the above embodiments, and in addition to the above embodiments, the present disclosure can be appropriately modified to be implemented without departing from the scope thereof.

What is claimed is:

1. A mower comprising:
a mower body including a cutting blade portion for cutting grass;
a first position estimation unit that estimates a self position of the mower body using a satellite positioning system;
a second position estimation unit that estimates the self position of the mower body using a sensor unit provided on the mower body;
a detection unit that detects a portion covered with plants on a preset traveling road; and
an automatic travel control unit that causes the mower body to travel on the traveling road with reference to the self position estimated by the first position estimation unit, and that causes the mower body to travel by switching so as to refer to the self position estimated by the second position estimation unit in the portion covered with the plants detected by the detection unit.

2. The mower according to claim 1, wherein the detection unit is configured to:
acquire RGB image data including color information and ortho image data, the ortho image data being data corresponding to an imaging area of the RGB image data and including point cloud data;
identify the plants based on the color information in the RGB image data; and
identify height of the plants based on height information of the point cloud data in the ortho image data to detect the portion covered with the plants.

3. The mower according to claim 1, wherein the detection unit compares first image data with second image data to detect the portion covered with the plants, the first image data being an image including the traveling road and acquired at a first time, and the second image data being data acquired at a second time different from the first time.

4. The mower according to claim 3, wherein:
the first time is a mowing time; and
the second time is a time in which there are less plants than the mowing time.

5. The mower according to claim 1, wherein the sensor unit includes at least one of a plurality of sensors including a distance measuring sensor, a camera, a gyro sensor, a magnetic sensor, an acceleration sensor, and a radar sensor.
